(19) United States
(12) Patent Application Publication
(10) Pub. No.: US 2003/0215123 A1
(43) Pub. Date: Nov. 20, 2003

(54) Method of embodying personal items with DNA fingerprints

(76) Inventor: Joseph Wing On Tam, Daly City, CA (US)

Correspondence Address: Raymond Y. Chan, 108 N. Ynez Avenue Suite 128, Monterey Park, CA, 91754, US

(21) Appl. No.: 10/147,348

(22) Filed: May 17, 2002

(51) Int. Cl. G06K 9/00

(52) U.S. Cl. 382/129

(57) ABSTRACT

A method of embodying personal items with DNA fingerprints includes the steps of producing a DNA fingerprint from a raw biological sample provided by a consumer by a service producer, purchasing a personal item by a user, and embodying the DNA fingerprint with the personal item, so that the expensive treasured ornaments can be provided with an unmistakable signature, i.e. the DNA fingerprints, to mark these ornaments for security purpose.

### FIELD OF INVENTION

The present invention relates to DNA fingerprints which can be used for commercial purpose as a method to personalized treasured items, such as ornaments, diary, garments, etc.

### DESCRIPTION OF RELATED ARTS

Nowadays, most of the consumer products are made by mass production. Different people may own an identical style of products, such as cellular phones, rings, necklaces, and etc. . . . Since they look like the same, if such treasured products are being mixed, you can't tell which is yours.

For example, even the police can find your lost items that were stolen from you; it may still be a big headache for you to proof whether they are your properties. Therefore, it will be a remarkable breakthrough to have an innovative method of embodying personal items with DNA fingerprints.

### SUMMARY OF THE PRESENT INVENTION

This is a main object of the present invention to provide a method of embodying personal items with DNA fingerprints, so that the expensive treasured ornaments can be provided with an unmistakable signature, i.e. the DNA fingerprints, to mark these ornaments for security purpose.

Another object of the present invention is to provide a method of embodying personal items with DNA fingerprints, wherein the DNA fingerprints of the treasured ornaments can be used as traditional family signature in many cultures. This is general will increase the intrinsic value both sentimental as well as commercial, of the ornaments as now the ornaments have a human history.

Another object of the present invention is to provide a method of embodying personal items with DNA fingerprints, wherein the treasured items with DNA fingerprints can be regarded as memorial or token of worship of diseased family members. The ornaments can replace existing plague or ash urn, thought they can all exist independently.

Another object of the present invention is to provide a method of embodying personal items with DNA fingerprints, wherein the DNA fingerprints on personalized items can be used as personalized identity, for preservation purpose.

Another object of the present invention is to provide a method of embodying personal items with DNA fingerprints, wherein the DNA fingerprints on ornaments can increase the market value of gifts or decorations.

Another object of the present invention is to provide a method of embodying personal items with DNA fingerprints, wherein the DNA fingerprints can be biological samples such as blood, buccal cell, hair, etc. without DNA extraction, though it will be more expensive with DNA extraction. A person interested in DNA personalized items can decide the mode of DNA fingerprints, with or without DNA extraction on the items.

Another object of the present invention is to provide a method of embodying personal items with DNA fingerprints, wherein ornaments include all products in jewelry stores and other items such as garments, clips belts, and other daily commercial products can also be embodied with DNA fingerprints, so long as it has a personal value to the customer.

### DETAILED DESCRIPTION OF THE PREFERRED EMBODIMENT

DNA fingerprint can be taking from biological samples such as blood, buccal cell, hair, etc. from living being such as human and pets. There are two categories of fingerprints. The first one is there raw biological samples, raw in the sense that it does not undergo DNA extraction. The second one is the biological samples with DNA extraction.

Both categories of fingerprints are processed in various degrees so that they can be preserved over a specified period of time. The person can decide the period of preservation after consulting the price from the service provider.

The method of embodying personal items with DNA fingerprints of the present invention includes the steps of:

(a) producing a DNA fingerprint from a raw biological sample provided by a consumer by a service producer;

(b) purchasing a personal item by a user; and

(c) embodying the DNA fingerprint with the personal item.

The personal item can be any mechanized purchased from a seller.

The DNA fingerprint can be a DNA extraction from the raw biological sample by the service producer. The DNA fingerprint can also be made as a DNA code for permanently printed or attached on the personal item.

The raw biological sample can be the user's own biological sample as his or her own blood, buccal cell, hair, etc. The user can also provide biological sample of another if the personal item is purchased for someone else.

The service producer may be authorized by the user to keep at least a record DNA fingerprint for comparison in future. The user himself or herself, of course, can also keep a record DNA fingerprint for future verification of his or her personal items that embodied with the DNA fingerprints respectively.

The seller of the personal item can deliver the purchased personal item of the user to the service provider for embodying the DNA fingerprint thereto. Also, the user may also authorize the service provider to deliver the DNA fingerprint to the seller for embodying the DNA fingerprint with the personal item.

Alternatively, the seller and the service provider can be contracted to provide the service for all users. So that, when the user purchases the personal item, the seller may collect the raw DNA biological sample from the user. Then the seller can be authorized by the use to deliver the raw DNA biological sample to the service provider to produce the DNA fingerprint. Finally, either the seller or the service provider can be authorized by the user to embody the DNA fingerprint with the personal item for the user.

In view of above, the present invention can substantially achieve the advantages and features as follows:

1. The expensive treasure ornaments can be provided with an unmistakable signature, i.e. the DNA fingerprints, to mark these ornaments for security purpose.

2. The DNA fingerprints of the treasured ornaments can be used as traditional family signature in many cultures. This in general will increase the intrinsic value both sentimental as well as commercial; of the ornaments as now the ornaments have a human history.

3. The treasured items with DNA fingerprints can be regarded as a memorial or token of worship of diseased family members. The ornaments can replace existing plague or ash urn, thought they can all exist independently.

4. The DNA fingerprints on personalized items can be used as personalized identity, for preservation purpose.

5. The DNA fingerprints on ornaments can increase the market value of gifts or decorations.

6. The fingerprints on items can be from human as well as from animals, such as pets.

7. The DNA fingerprints can be biological samples such as blood, buccal cell, hair, etc. without DNA extraction, though it will be more expensive with DNA extraction. A person interested in DNA personalized items can decide the mode of DNA fingerprints, with or without DNA extraction, on the items.

8. The ornaments include all products in jewelry stores and other items such as garments, clips, belts, and other daily commercial products can also be embodied with DNA fingerprints, so long as it has a personal value to the customer.

What is claimed is:

1. A method of embodying personal items with DNA fingerprints, comprising the steps of:
(a) providing a DNA fingerprint belonged to a consumer to form a DNA fingerprint record;
(b) attaching said DNA fingerprint to a purchased item of said consumer; and
(c) verifying whether said item belongs to said consumer by matching said DNA fingerprint record with said DNA fingerprint on said item.

2. The method of embodying personal items with DNA fingerprints, as recited in claim 1, wherein said DNA fingerprint is made as a DNA code and attached on said item.

3. The method of embodying personal items with DNA fingerprints, as recited in claim 1, wherein said DNA fingerprint is directly exacted from raw biological sample of said consumer.

4. The method of embodying personal items with DNA fingerprints, as recited in claim 1, wherein said DNA fingerprint is extracted from a biological sample of an animal belonged to said consumer.

5. The method of embodying personal items with DNA fingerprints, as recited in claim 2, wherein said step (b) further comprises a step of sending said purchased item to a service provider for attaching said DNA fingerprint to said purchased item.

6. The method of embodying personal items with DNA fingerprints, as recited in claim 3, wherein said step (b) further comprises a step of sending said purchased item to a service provider for attaching said DNA fingerprint to said purchased item.

7. The method of embodying personal items with DNA fingerprints, as recited in claim 4, wherein said step (b) further comprises a step of sending said purchased item to a service provider for attaching said DNA fingerprint to said purchased item.

8. The method of embodying personal items with DNA fingerprints, as recited in claim 2, wherein said step (b) further comprises a step of sending said DNA fingerprints to a seller of said purchased item of said consumer for attaching said DNA fingerprint to said purchased item.

9. The method of embodying personal items with DNA fingerprints, as recited in claim 3, wherein said step (b) further comprises a step of sending said DNA fingerprints to a seller of said purchased item of said consumer for attaching said DNA fingerprint to said purchased item.

10. The method of embodying personal items with DNA fingerprints, as recited in claim 4, wherein said step (b) further comprises a step of sending said DNA fingerprints to a seller of said purchased item of said consumer for attaching said DNA fingerprint to said purchased item.

11. The method of embodying personal items with DNA fingerprints, as recited in claim 5, wherein said step (a) further comprises a step of preserving said DNA fingerprint record for a predetermined period of time for multiple verifications.

12. The method of embodying personal items with DNA fingerprints, as recited in claim 6, wherein said step (a) further comprises a step of preserving said DNA fingerprint record for a predetermined period of time for multiple verifications.

13. The method of embodying personal items with DNA fingerprints, as recited in claim 7, wherein said step (a) further comprises a step of preserving said DNA fingerprint record for a predetermined period of time for multiple verifications.

14. The method of embodying personal items with DNA fingerprints, as recited in claim 8, wherein said step (a) further comprises a step of preserving said DNA fingerprint record for a predetermined period of time for multiple verifications.

15. The method of embodying personal items with DNA fingerprints, as recited in claim 9, wherein said step (a) further comprises a step of preserving said DNA fingerprint record for a predetermined period of time for multiple verifications.

16. The method of embodying personal items with DNA fingerprints, as recited in claim 10, wherein said step (a) further comprises a step of preserving said DNA fingerprint record for a predetermined period of time for multiple verifications.
